(19) United States
(12) Patent Application Publication
(10) Pub. No.: US 2018/0255715 A1
(43) Pub. Date: Sep. 13, 2018

(54) Modular Versatile Plant Protection System

(71) Applicant: Chrisantha Ajith Demel, Atens, OH (US)

(72) Inventor: Chrisantha Ajith Demel, Atens, OH (US)

(21) Appl. No.: 15/911,384

(22) Filed: Mar. 5, 2018

Related U.S. Application Data
(60) Provisional application No. 62/469,891, filed on Mar. 10, 2017.

(51) Int. Cl. A01G 13/10; A01G 13/02

(52) U.S. Cl. CPC A01G 13/10; A01G 13/0243

(57) ABSTRACT

A modular structure to protect plants and bulbs from deer and other wild animals comprising of connectable vertical poles and open-ended circles placed horizontally through eyelets located on the vertical poles. Flexible mesh or netting is wrapped around the structure and attached on to specially designed hooks on one of the vertical poles. Modular and flexible design features makes it possible for the plant protection system to be extended, widened, slanted, and be modified to enclose plants on different types of surfaces and stages of growth. The open-ended circles and connectable vertical poles make it possible for the system to be built around a plant or be dismantled piece by piece without having to damage the plant or the enclosure. System constructed with light weight materials and connectable parts makes it possible for all the necessary components to be in one package that can be shipped or picked up by do-it-your-self consumers in need of a plant and bulb protection systems that can be easily assembled by themselves without tools.

### BACKGROUND OF INVENTION

Home owners spend countless hours and a considerable amount of time and money every year on landscaping with the expectation of having blooming plants, healthy shrubs, and trees with fruits and vegetables. Their expectations are shattered when bulbs are dug out by wild animals and young plants, leaves, shoots, buds, and flowers are eaten or destroyed by deer and other wild animals.

Recently there has been the development of chemical and organic sprays to deter deer and other wild animals from plants. However, this method of protection is rather expensive and in-effective due to rain washing away the liquid after it is sprayed. It also creates an odor, and is harmful to the environment, insects, and microbes living in the soil.

Another method of protection used in recent years is to convert large heavy fifty foot rolls of wire or plastic mesh into plant enclosures. The drawback to this method is home owners having to transport large rolls and hire professionals to construct the enclosures. Mesh enclosures tend to corrode over time, look hideous in the winter, and are difficult to insert and remove when the plant branches out.

Plastic deer netting, chicken wire mesh, and welded mesh are attached to plastic rods, wood or flat iron fencing post to fence off animals from plants. This method also requires transport of materials and hired labor.

Electric fences are another expensive way of protecting plants. However, home owners prefer not to use this method due to high cost of installation and danger to small animals and children.

In addition to growing plants and trees directly on soil, most gardeners also grow plants and bulbs in containers placed on wooden decks and brick patios. Because it is not possible to attach wire or plastic mesh cylinders onto brick patios, concrete floors, or wooden decks, plants on such surfaces are not protected from animals.

Plants grown on sloped or uneven terrain cannot be protected with typical round plastic mesh or wire cylinders because the top edge of the cylinder restricts the tree top because it is placed at a slant. Further, because the device is placed on a slope it is easily toppled or blown away by strong winds. Also a plant protection device placed around a tree on a slope is not aesthetically pleasing to the eye because the top edge of the cylinder is not perpendicular to the trunk of the tree.

One of the biggest problems associated with using existing wire or plastic cylindrical devises available in the market is its inability to be modified to accommodate the needs of a growing plant. In addition, when placing or removing a pre-constructed wire cylinder from a tree that has branched out, the flowers and branches are damaged in the process.

With the advent of the internet, a majority of consumers prefer ordering home and garden products on-line or picking them up at one-stop big box garden centers. Even though online garden catalog companies and retailers offer rolled mesh, various types of fencing posts, and all the accessories required to construct protection devices for plants, I have not yet found a compact, versatile, ready to assemble, modular system with all the necessary components in one carton that can be shipped or picked up.

The invention of the MODULAR VERSITLE PLANT PROTECTION SYSTEM is a protective coverings for plants and a tree trunk guard for plant husbandry as in Classification 47/32.4, 47/29.5 and a fencing or enclosure and adjustable structure for agriculture as defined in International Classification A01G13, E04H17.

### BRIEF SUMMARY OF THE INVENTION

The preferred embodiment in the present invention is a modular, expandable, and versatile system constructed with interchangeable parts to provide protection for bulbs and trees from deer and other wild animals. In the preferred embodiment, a frame constructed with vertical poles and circles, is enclosed with a flexible piece of mesh or netting.

Vertical poles comprise of one starter pole and one or more support poles. Starter pole and support poles comprise of a top section and a bottom section connected by a ferrule. The term vertical pole(s) will be used hereafter to refer to a top section and a bottom section connected by a ferrule. Starter and support poles may be constructed with round low carbon steel, wrought iron, fiberglass, plastic, or any other suitable materials and be finished with a coating for durability.

The two circles are open-ended and can be closed or opened by a ferrule at the end of the circles. Circles may be constructed with the same materials as the vertical poles or alternatively with spring steel which can be coiled into a smaller diameter circle to occupy less storage space. Circles may be constructed with the same size diameters as the vertical poles or of a smaller diameter for easy coiling and to provide a spring like effect to keep the end from slipping out of the ferrule.

The said frame is assembled by guiding the rod end of each circle through the eyelets on the support poles and closing the circles by pushing in the open-end of the circle into the ferule. The assembled frame is firmly secured to the ground and tightly wrapped with a rectangle piece flexible mesh or netting preferably made of UV treated synthetic or natural materials.

Flexible mesh or netting is firmly attached to the said frame by means of several specially designed hooks on the top and bottom sections of the starter pole. It is further secured with several wire or plastic ties, binding the mesh or netting to the said frame in several additional places along the two circles and vertical poles.

The materials and methods described above are the most suitable for the construction of the Modular system, but it should not be interpreted as the only materials suitable to construct the system.

The modular system in the preferred embodiment is designed to build an enclosure around a tree or be constructed away from the tree and be placed over a tree on penetrable surface. The constructed system is secured to the penetrable surface by exerting pressure on the several horizontal rods protruding from the end of the vertical poles.

In another embodiment of the invention, the preferred embodiment is modified by attaching a different style of bottom sections to the same top sections to protect plants and bulbs grown in containers placed on non-penetrable hard surfaces such as brick, concrete, or wooden decks.

In another embodiment of the invention, the preferred embodiment is modified by attaching different sizes of the top section to the same bottom sections to accommodate tall trees. It should be noted that the system is designed to accommodate more than one size of top sections and is not limited to one size. Since the modular system is designed to accept interchangeable parts it is possible for the same embodiment to have a different style of bottom sections, making it possible for the system to be used on penetrable or hard surfaces.

In another embodiment of the invention, the preferred embodiment is modified by attaching circles of different diameters to the vertical poles to expand the system to accommodate wider trees. It should be noted that the system is designed to accommodate more than one diameter of circles and not just limited to one diameter of circles. Since the modular system is designed to accept interchangeable parts it possible for the same embodiment to have different types of bottom sections making it possible to use the embodiment on penetrable soil and on hard surfaces.

In another embodiment of the invention, the preferred embodiment is modified to accommodate plants grown on slopes or uneven terrain by adjusting the angle of the circles to be parallel to the surface of the soil. For this embodiment, the said frame is enclosed with an alternative mesh or netting with slits cut at the bottom edge. The divisions created by the slits at the bottom edge of the mesh or netting can be arranged along the slope of the terrain so the circles and top edge of mesh or netting will be in a horizontal plane. Flexibility of the circles to freely move from a horizontal position to any other required position makes it possible for the system to be constructed on sloped or on uneven terrains.

### Objects and Advantages

The main object of my invention is to provide the do-it-your-self consumers a versatile plant enclosure system that is light weight, easy to modify, and be constructed without tools or hired labor. In addition, there are several other advantages to the invention as described below:

A modular system with interchangeable components allows the same system to be expanded to accommodate taller and wider trees.

A modular system with interchangeable components also allows customer to modify the system to be used on different surfaces such as penetrable and hard surfaces.

A modular system designed with light weight sectional support poles, circles, and flexible mesh or netting, allows all the required components of the system to be packaged in a carton which cost less to ship, easy to transport, and occupies less retail and storage space making it a more desirable product for big box retailers, catalog companies, and internet retailers.

Flexible joints in the frame and the use of mesh or netting with slits at the bottom edge allows the system to be installed on sloped or uneven terrains.

A modular design gives the consumer the choice of constructing the enclosure around a tall grown tree or inserting a fully constructed system over a tree. It can also be dismantled piece by piece without breaking the branches or damaging the tree.

A modular design give the consumers the choice of ordering replacement and system modification parts such as top extensions, bottom sections (L shaped or tapered end), wider circles, and alternative style of mesh or netting making the system adaptable, re-usable and repairable.

In prior art work examined (U.S. Pat. No. 9,351,449B2 Williams, U.S. Pat. No. 3,816,959, Nalle U.S. Pat. No. 2,753,662, Behnke, U.S. Pat. No. 5,930,948, Daniel, U.S. Pat. No. 2,996,842 Weston, U.S. Pat. No. 951,807 Erdely, U.S. Pat. No. 1,552,445 Peres, U.S. Pat. No. 2,009,867 Ball, U.S. Pat. No. 4,858,380 Gayle), the plant protection systems are not modular, therefore not expandable to accommodate the growth of the plant (height, width) or be modified to suit different surfaces(soil, bricks, slanted terrain) Further, they are not designed with connectable components or flexible mesh or netting, making the total system compact, light weight, and small enough to fits in a box for commercialization and easy shipping. Therefore there is a need for a new modular, versatile plant protection system.

### BRIEF DESCRIPTION OF SEVERAL VIEWS OF THE DRAWINGS

FIG. 1 is a front view of the preferred embodiment fully assembled and erected on flat penetrable soil.

FIG. 2 illustrates the frame of the preferred embodiment assembled with two circles horizontally oriented and attached to three vertical poles by means of eyelets located on top and bottom sections of three vertical poles. Bottom section of the support poles are tapered to penetrates soil surface.

FIG. 3 through 8 shows the unassembled top and bottom sections of starter and support poles for the preferred embodiment. It should be noted, for illustration purposes, only one length of the top sections of starter and support poles are illustrated.

FIGS. 9 and 10 illustrates the two open-ended circles in the preferred embodiment. It should be noted, for illustration purposes, only one diameter of circles is illustrated.

FIG. 11 illustrates the front view another embodiment constructed with alternative bottom sections for the system to be placed on a hard surface such as a brick patio or wooden deck.

FIG. 12 illustrates the assembled frame of the embodiment described in FIG. 11, constructed with two circles horizontally oriented and attached to vertical poles by means of eyelets located on top and bottom sections of vertical poles. Bottom sections of the vertical poles are bent at ninety degree angles for the system to be placed on a hard surface.

FIG. 13 through 18 illustrates unassembled top and bottom sections of starter and support poles of the embodiment described in FIG. 11. It should be noted, for illustration purposes, only one height of the top section is illustrated.

FIG. 19 is the front view of the ferrules used to connect top and bottom sections of starter and support poles. Same ferrule is used for connecting circles in all of the embodiments described.

FIG. 20 is a cross sectional view taken along line 34-34 in FIG. 19.

FIG. 21 is the side view of the eyelets used with the top and bottom sections of the starter and support poles.

FIG. 22 is the top view of the “C hook” used on top and bottom section of the starter pole.

FIG. 23 is the side view of another embodiment of the invention erected on a sloped or uneven terrain.

FIG. 24 is the cross sectional view taken along line 35-35 in FIG. 23 illustrates how the circle inserted through the eyelets allows the horizontal orientation of the circles' plane to move freely up or down, providing flexibility to the frame.

FIG. 25 is the natural shape of an unfolded piece of mesh or netting. The same type of mesh or netting is used in all the embodiments described, except for the embodiment designed for a sloped terrain shown in FIG. 23 It should be noted, for illustration purposes, only one height and length of the rectangle mesh or netting is shown.

FIG. 26 is the front view of rectangle piece of mesh or netting with slits at the bottom edge used in embodiment shown in FIG. 23. It should be noted, for illustration purposes, only one height and length of the rectangle mesh or is netting shown.

FIG. 27 is the top view of the preferred embodiments and all other embodiments, showing the placement of the support poles erected in clock hand positions of two, six, and ten, and the placement of the circle around a tree. It should be noted, that support poles can be erected in any position along the perimeter of the circle, as long as they are evenly spaced apart to form a triangle.

FIG. 28 is front view of the top left edge of the mesh or netting showing how the left arm of the top “C hook” is attached to the mesh or netting.

FIG. 29 is the front view of the top section of the mesh or netting showing how the two ends overlap, and how the top right edge of the mesh or netting is attached to the right arm of the “C hook”.

FIG. 30 is a view of an optional length of wire or plastic that may be included with the unit. It will be pliable enough to twist around the contact points of the metal frame of the enclosure and the mesh to further secure it and prevent slipping.

### DETAILED DESCRIPTION OF THE INVENTION

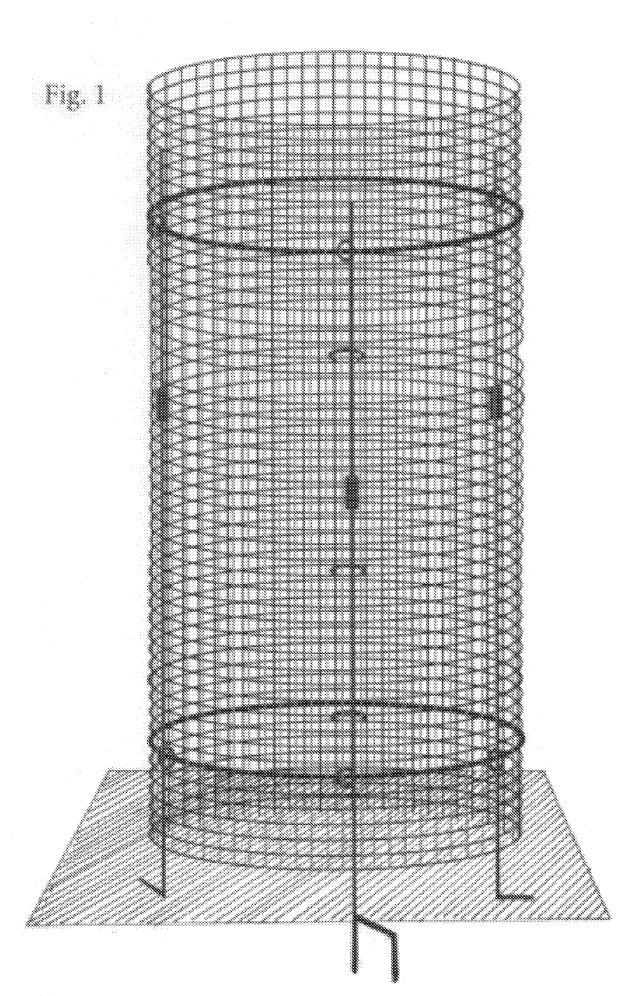

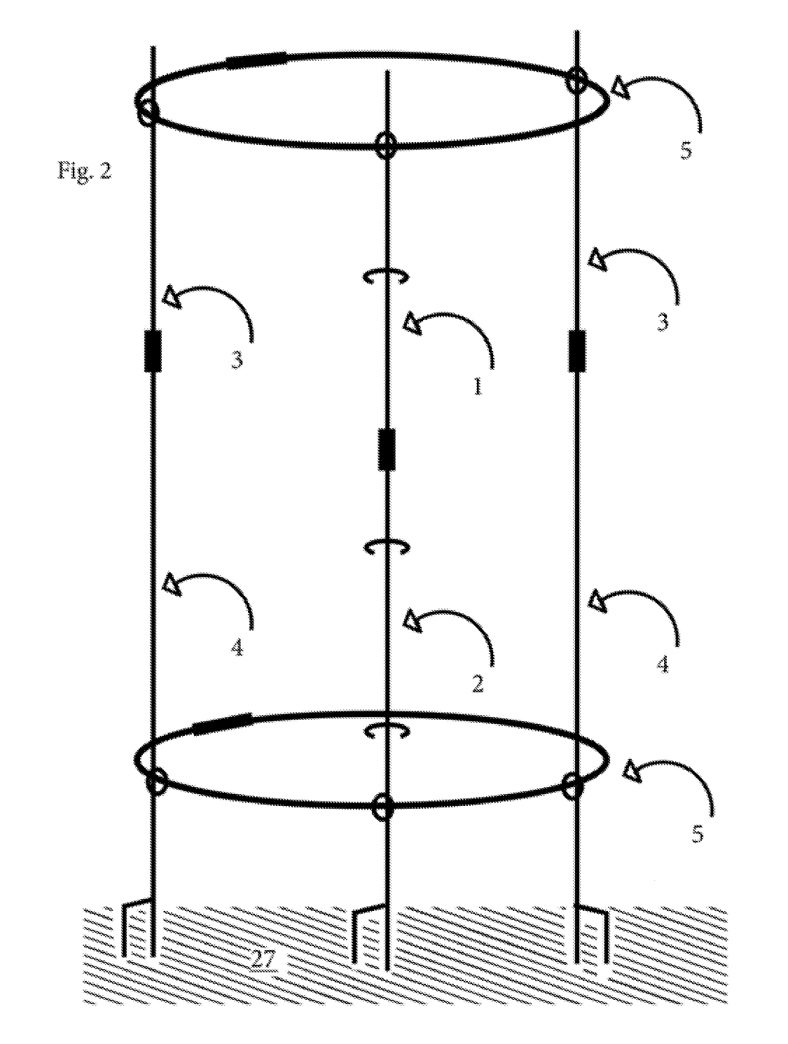

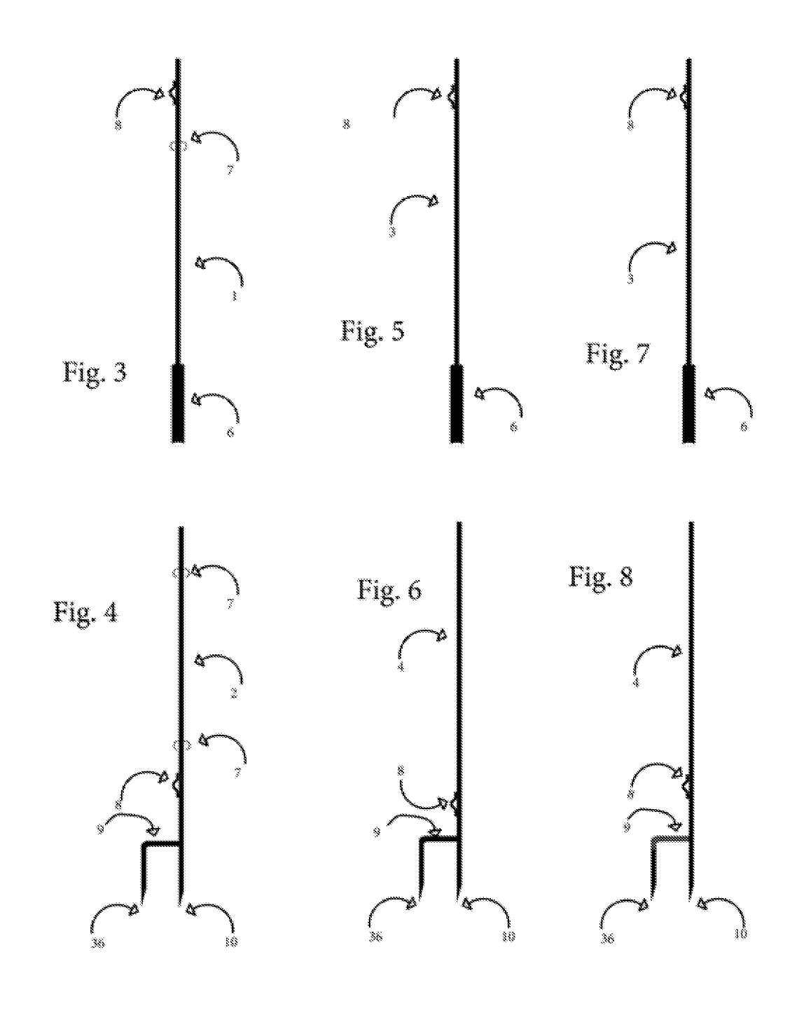

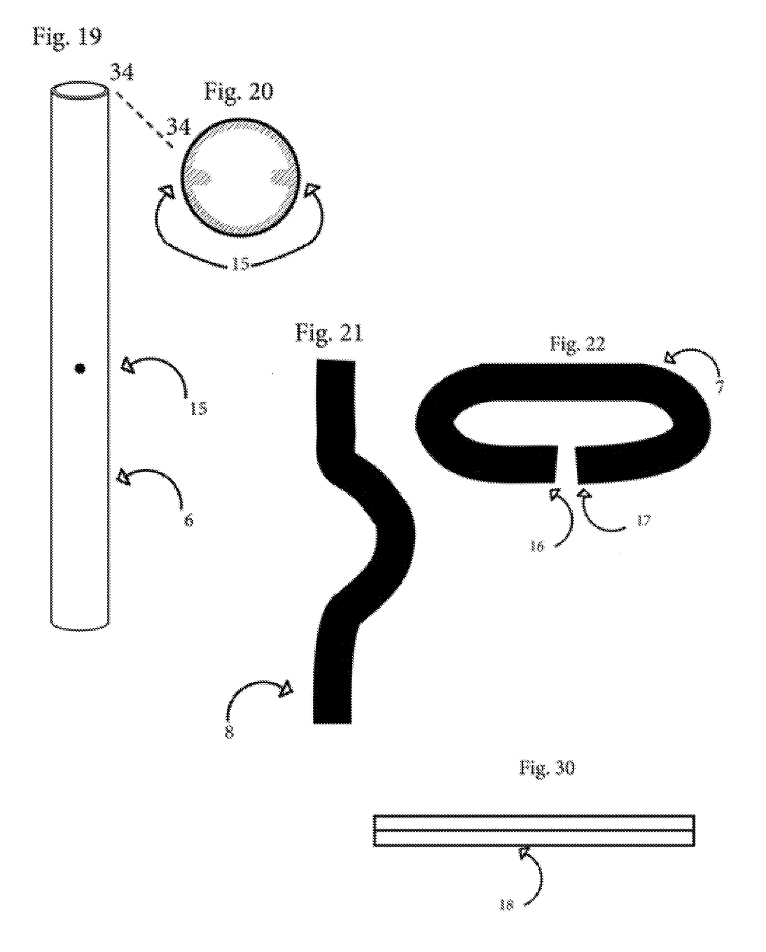

A front view of the invention fully assembled on penetrable soil is shown in FIG. 1. FIG. 2 shows the front view of the assembled frame of the preferred embodiment consisting of two circles 5 and three vertical poles made up of top section of starter pole 1, top section of support poles 3, bottom section of starter pole 2, and bottom section of support pole 4 fixed to a penetrable soil surface 27. FIG. 3 shows the individual components of the starter and support poles. The top and bottom sections are connected together by ferrules 6 shown in FIG. 19.

Ferrule 6 in FIG. 19 may be made of thin wall tubing or a UV treated synthetic material where the inner wall diameter of the ferrule is a few millimeters larger than the outer diameter of the pole ends inserted into the open end of the ferrule 6. The connected sections can be taken apart to modify the system if necessary. Ferrule 6 may be welded to the bottom end of the top section poles 1, 3 or the ferrule can be a standalone piece that can be used as a connector because the middle point of the ferrule has two indent points 15 pressed on both sides of the hollow tube as shown in FIG. 20 to stop the pole ends from sliding more than half the length of the ferrule.

Circles 5 are connected to vertical poles by means of eyelet 8. Eyelets are welded 19 as shown in FIG. 24 to the body of the starter and support poles a few inches away from the top and bottom ends of the poles. The top section of starter pole 1 and top sections of support poles 3 have one eyelet per piece welded and the bottom part of starter pole 2 and bottom part of support pole 4 have two eyelets per piece welded to them. Eyelet 8 is used as a mechanism to connect the two circles 5 to the three vertical poles and provides a joint so the planes of the circles can be changed. A very small tolerance between the walls of the eyelet and the outer surface of the circle permits the plane of the circle to freely move up and down or be turned around when necessary.

FIG. 22 is the front view of “C hook”7 which is used to start and end the process of attaching the plastic mesh or netting to the said frame of the preferred embodiment shown in FIG. 2. It also acts as a mechanism to hold the mesh or netting tightly onto the frame. The distance between the left arm end 16 and right arm end 17 of the “C hook” 7 is a few millimeters larger than the thickness of the mesh or netting filament. The top section of the starter pole 1 has one welded “C hook” 7 and the bottom section of the starter pole 2 has two welded “C hooks” 7.

As shown in FIG. 4, 6, 8, the ends of the bottom sections of starter poles 2 and support poles 4 are tapered 10 at the end to penetrate the moistened soil surface 27. An “L” shaped rod with one tapered end 36 is turned upside down and welded to the bottom section of starter pole 2 and support poles 4. The piece of the rod welded perpendicularly towards the end of bottom sections 2, 4 is hereafter referred to as the foot plate 9. Foot plate 9 is used to exert pressure to drive the system into penetrable soil 27.

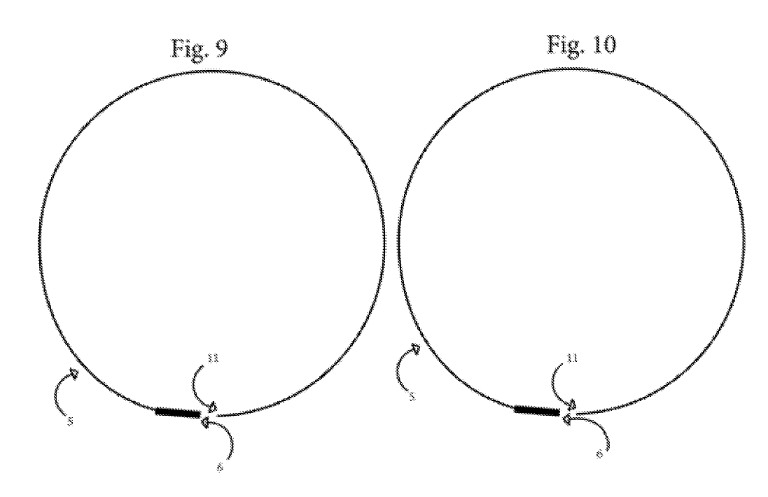

The open-ended pair of circles 5 in FIG. 9 and FIG. 10 may be fabricated with low carbon steel, wrought Iron, spring steel, or any other suitable material and may finished with powder coating or any other finish for durability and weather resistance. Ends of the open circles 5 have ferrules 6 welded or attached in the same manner described for the vertical poles.

### Assembly of Invention

The modular plant protection system can be assembled around the plant 29 if the plant is tall and wide or the system can be constructed away from the plant and be placed over the plant if the plant is not too tall. The instructions given below are for assembling the preferred embodiment around a tall branched out plant 29.

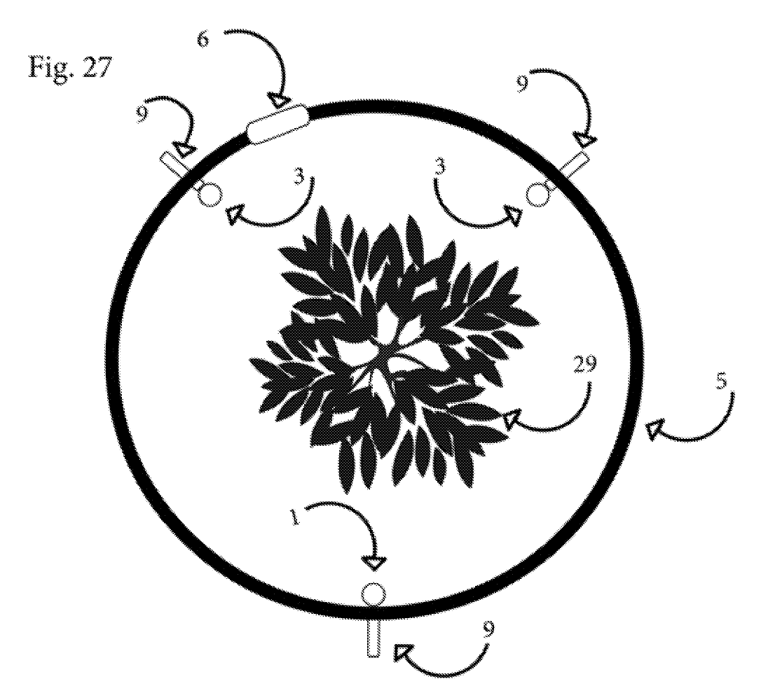

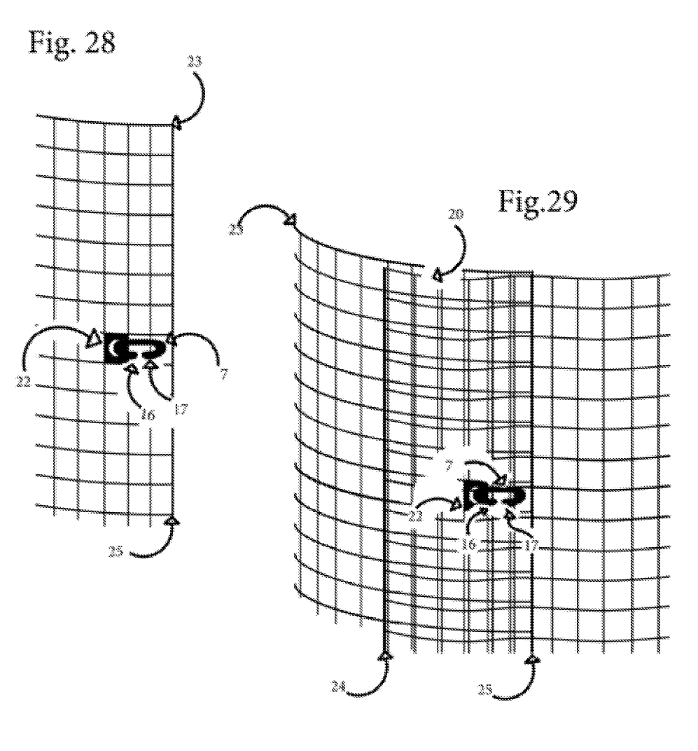

Connect the top sections 1, 3 shown in FIG. 3 and FIG. 5, and bottom sections 2,4 shown in FIG. 4 and FIG. 6. Place the open end circle 5 over the trunk centering the plant 29 as shown in FIG. 27. Take the assembled starter pole and place the tapered end 10 approximately a quarter of an inch outside the circle 5 where the tapered end 10 is in clock hand position six. Rotate the pole so the pressure foot 9 and the “C hooks” 7 are perpendicular to the circle 5. Firmly press the pole a few inches into the ground using the foot plate 9 located on the bottom of the pole. Erect the other two assembled support poles in clock hand positions two and ten in the same manner. Slide out or remove the open-ended circle 5 away from the plant 29 and the three erected support poles. Insert the open end 11 of circle 5 through all the eyelets 8 on the bottom sections of poles and close the circle by pushing in the open-end 11 into the open-end of the ferrule 6. Insert the open-end 11 of the second circle 5 through all the eyelets 8 on the top section of all 3 poles and close the circle in the same manner. Now that the frame is assembled, further attach the frame to the ground by exerting pressure on the pressure plate 9 on all three foot plates until the bottom surface of the pressure plate 9 is resting on surface 27.

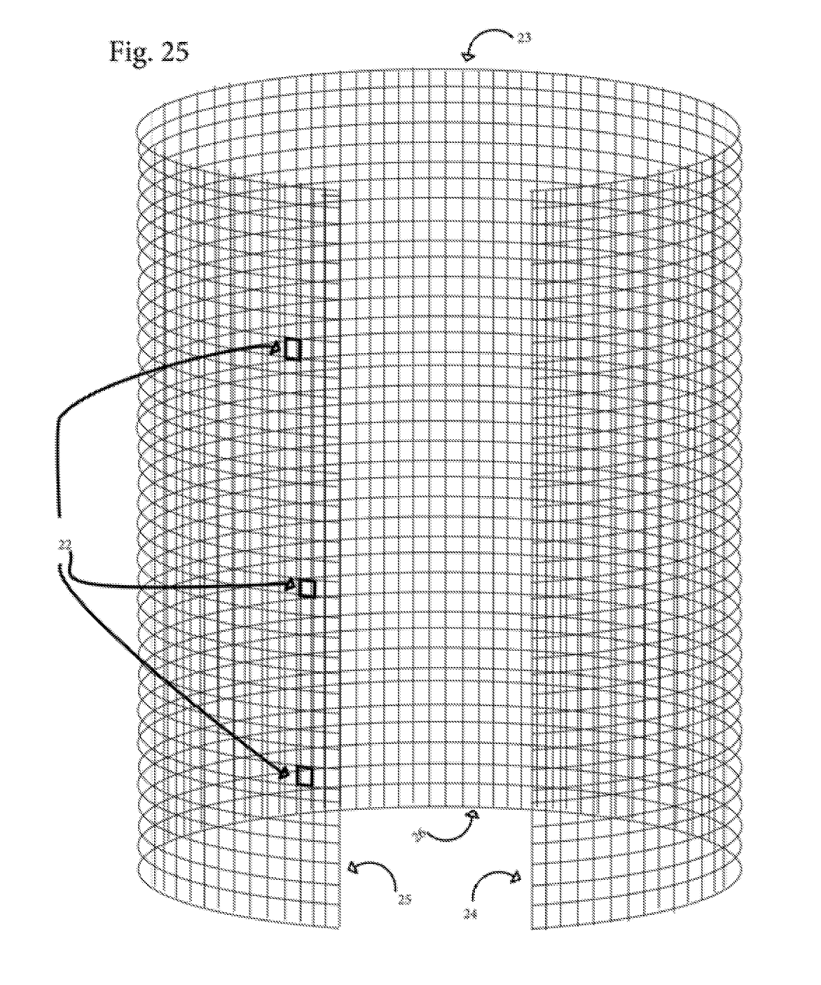

To attach the mesh or netting illustrated in FIG. 25, take the left edge 25 of the mesh or netting and thread the right filaments of the highlighted squares 22 in the mesh or netting through left arm 16 of “C ring” 7 located on the top section of starter pole 1 and bottom section of starter pole 2. Pull and take the rectangle mesh or netting around the other two vertical poles completing a full circle until the edge 24 overlaps edge 25 by a few inches as shown in FIG. 29. Select a column of mesh or net opening on edge 24 which will give the mesh the tightest fit around the frame. Pull the selected mesh or net column slightly towards vertical starter pole to stretch the left filament of the selected mesh column directly over the right arm 17 of the “C hook” 7. Insert the stretched filament of the mesh or net through the small gap between right arm 16 and 17 of “C hook 7”.

After the mesh is fitted on to the frame, the top end 23 of the mesh or netting will be a few inches taller than the upper circle 5. The mesh or netting bottom edge 26 extends vertically below the bottom circle 5 touching the planting surface 27 to prevent small animals from crawling beneath the plant protection system.

Now that the assembly is complete, to prevent the mesh cylinder from sliding down or moving around the frame, use ties 18 in FIG. 30 to tie the mesh on to the circles 5 and vertical poles for additional security.

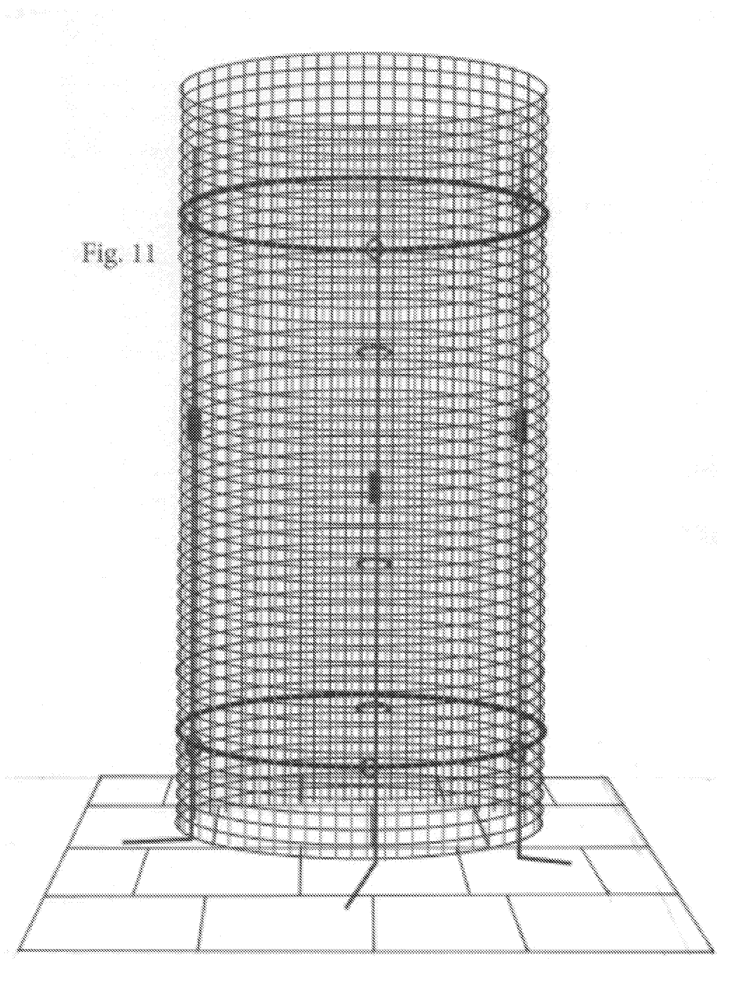

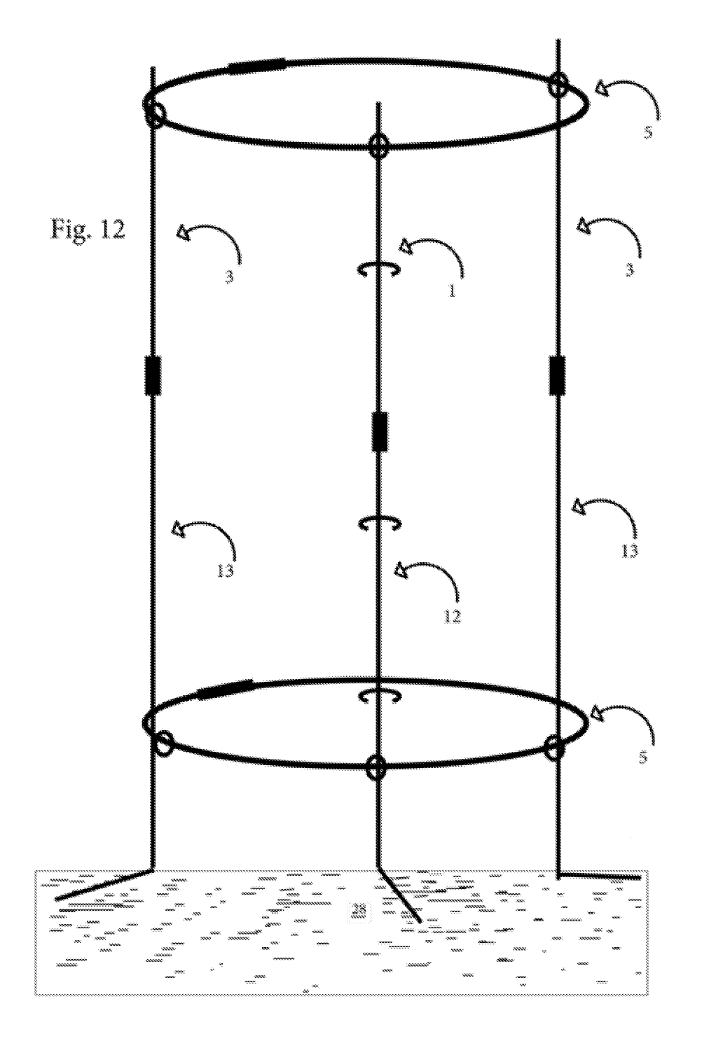

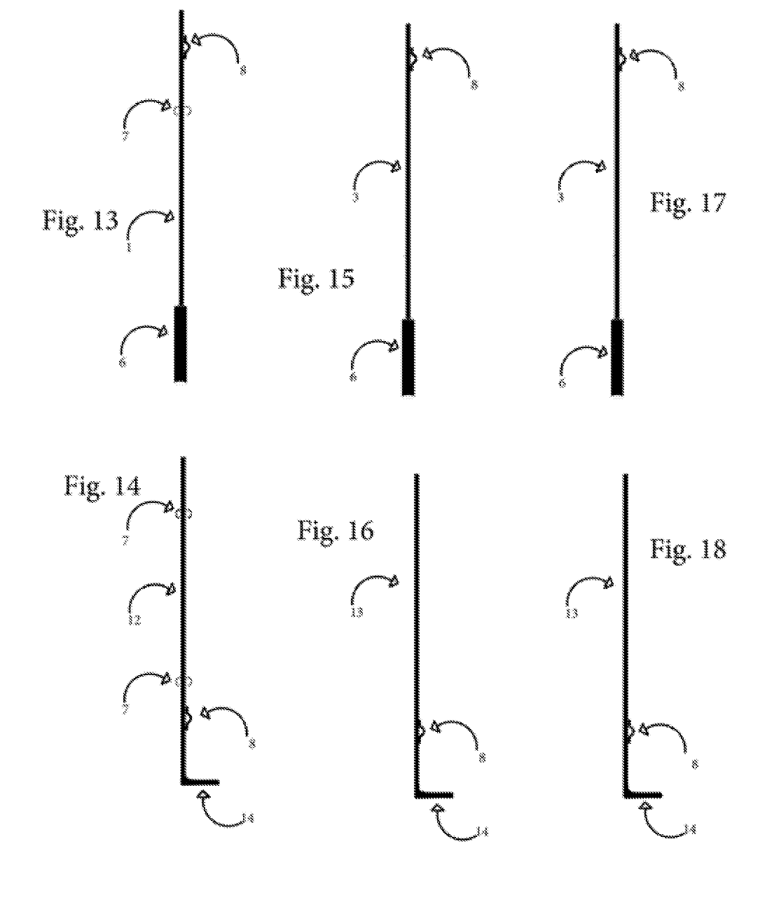

In another embodiment of the invention is shown in FIG. 11 where the preferred embodiment is modified for the modular plant protection system to be placed on a hard surface such as brick 28 or a wooden deck. FIG. 12 shows the fully assembled frame of the modified embodiment with a different style of bottom sections of starter pole 12 and support poles 13. FIG. 13 through 18 shows the unassembled top section 1,3 and bottom section 12,13 of the vertical poles for this embodiment. The end of the bottom sections 12,13 are bent at ninety degree angles to form an “L” shape foot. The method of attaching the circles 5 to the vertical support poles and attaching the mesh or netting to the frame is the same as in the preferred embodiment. It should be noted that, since the system is modular where interchangeable parts can be used, the same components used in the preferred embodiment; circles, top sections are used in the modified embodiment.

In another embodiment of the invention, the preferred embodiment is modified by attaching different sizes of top sections (not shown in drawings) to extend the height of the system. The method of attaching the circles to the support poles and attaching the mesh or netting to the frame is the same as described for the preferred embodiment. It should be noted that, since the system is modular where interchangeable components can be used, the same circles and bottom sections used in the preferred embodiment can be used in this embodiment.

In another embodiment of the invention, the preferred embodiment is modified by attaching a different size of circles (not shown in drawings) to the system to accommodate wider trees. The method of attaching the circles to the support poles and attaching the mesh or netting to the frame is the same as described for the preferred embodiment. It should be noted that, since the system is modular where interchangeable components can be used, the same top and bottom sections used with the preferred embodiment can be used in this embodiment.

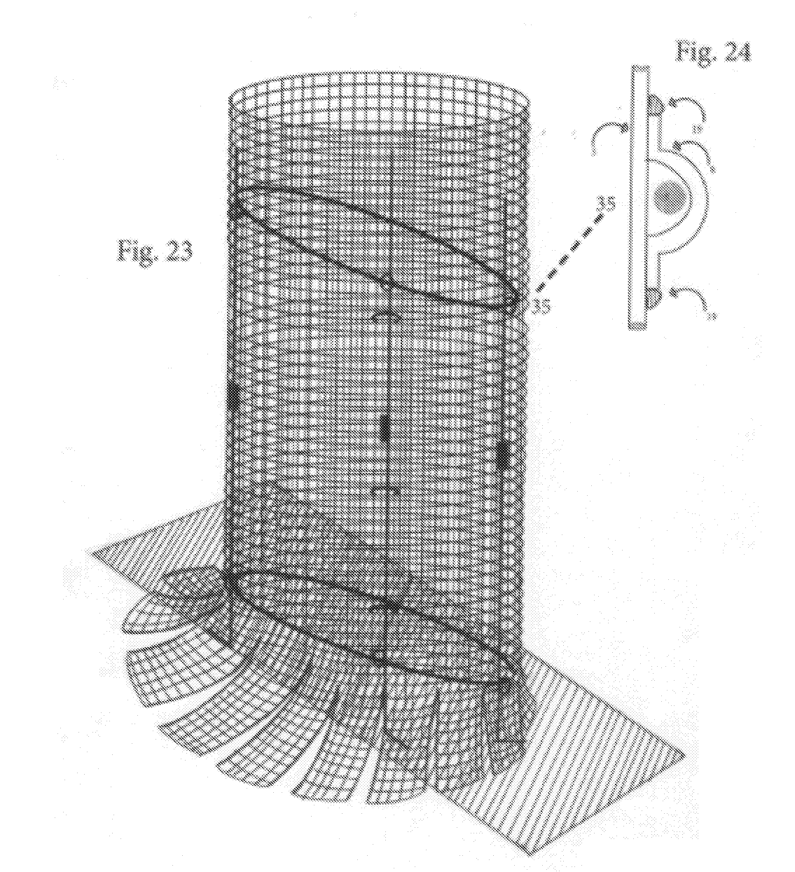

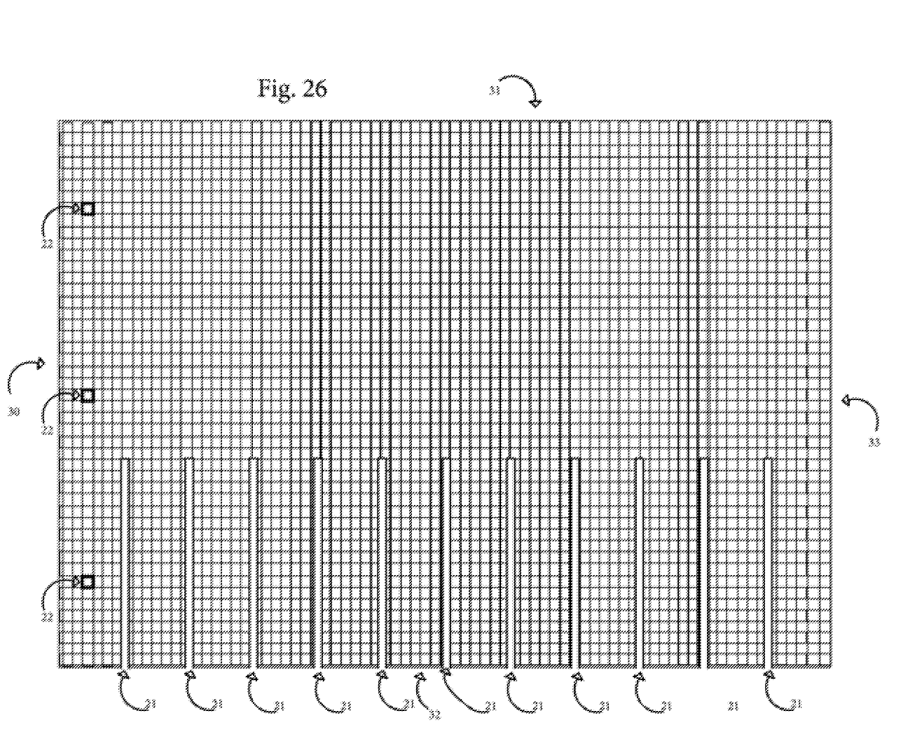

In another embodiment of the invention, the preferred embodiment is modified for the modular plant protection system to be placed on a slope or uneven surface as shown in FIG. 23 where the bottom support pole are at different levels. When the modular system is erected on a slope or uneven surface, the shape of the frame can be changed from the circles being perpendicular to the support poles to the circles being pararelle to the surface as shown in FIG. 23. The method of attaching the circles to the support poles is the same as described for the preferred embodiment. For this embodiment, the mesh or net shown in FIG. 26 with several slits 21 at the bottom edge 32 is attached to the frame in the same manner as described for the preferred embodiment. Because of the slope of the terrain, the bottom edge 32 should be bent and arranged along the slope terrain as shown in FIG. 23.

What is claimed is:

1. A modular plant protection system to protect plants from deer and other wild animals comprising: plurality of vertical poles, plurality of circles secured horizontally to the said vertical poles by means of plurality of eyelets located on said vertical poles, creating a flexible structure, enclosed with a flexible mesh or netting secured to the structure by means of plurality of hooks located in one of the said vertical poles, creating a enclosure, secured to a penetrable surface.

2. The modular plant protection system of claim 1, wherein; said vertical poles comprise of top and bottom sections, connected by a ferrules.

3. The modular plant protection system of claim 1, wherein; the two ends of said bottom vertical poles are tapered.

4. The modular plant protection system of claim 1, wherein; rods bent at a ninety degree angles with one end tapered, the other end attached to the bottom ends of the said vertical poles provides stability and a means of attaching the structure to a penetrable surface without tools.

5. The bent rod sections of claim 4 wherein: said bent rods attached to the ends of the said vertical poles acts as foot plates to exert pressure on the said vertical poles to secure the structure to a penetrable surface without the aid of tools.

6. The modular plant protection system of claim 1, wherein; top and bottom sections of the vertical poles comprises plurality of eyelets which acts as flexible joints and provides a means to connect the said plurality of circles to the said plurality of vertical poles to form a flexible structure.

7. The modular plant protection system of claim 1, wherein; said flexible structure is enclosed with a flexible piece of mesh or netting.

8. The modular plant protection system of claim 1, wherein; said flexible structure is enclosed with a flexible piece of mesh or netting with plurality of slits at the bottom edge.

9. The modular plant protection system of claim 1, wherein: plurality of hooks located perpendicular to the support poles are used to receive the filaments on the left and right edges of the rectangle mesh or netting, and also acts as a means of securing the mesh or netting to the structure.

10. The modular plant protection system of claim 1, wherein; said mesh or netting is attached to the support pole first by inserting plurality of chosen filaments on the mesh or netting to the left arm of the “C hook” located on the said support pole and complete attaching the mesh or netting to the frame by inserting plurality of chosen filament on the mesh or netting on the opposite end, to the right arm of the “C hook” on the said support pole leaving a overlap between the two edges.

11. The modular plant protection system of claim 1 wherein, said mesh or netting is further secured to the frame by means of plurality ties.

12. The modular plant protection system of claim 1, wherein: the bottom sections of the vertical supports can be changed to place the system on non-penetrable surface.

13. The modular plant protection system of claim 1, wherein: the top sections of the said vertical poles can be replaced with different sizes of top sections.

14. The modular plant protection system of claim 1, wherein, said plurality of circles are opened and closed by means of ferrules.

15. The modular plant protection system of claim 1, wherein: the said plurality circles can be removed and exchanged with plurality of circles of different diameters.

16. The modular plant protection system of claim 1, wherein, the plurality of circles secured to the vertical poles by means of said plurality of eyelets allows the of the said plurality of circles to be changed from being horizontal to being parallel to the slope of the surface.
